(19) United States
(12) Patent Application Publication
(10) Pub. No.: US 2003/0209903 A1
(43) Pub. Date: Nov. 13, 2003

(54) Planning organizer

(76) Inventor: John M. Morris, Ship Bottom, NJ (US)

Correspondence Address: Hollstein Keating Cattell Johnson & Goldstein P.C, Willow Ridge Executive Office Park, Suite 301, 750 Route 73 South, Marlton, NJ, 08053, US

(21) Appl. No.: 10/152,472

(22) Filed: May 10, 2002

(51) Int. Cl. B42F 21/00

(52) U.S. Cl. 283/42

(57) ABSTRACT

A planning or event organizer comprises dual, rigid covers, onto which organizer components are detachably supported. Items such as a notebook and an expandible folder can be detachably contained within the covers of the organizer. A flexible binder, secured to one of the covers, is insertable into an opening in the other cover, to interconnect the covers and form the organizer. The binder is slidably adjustable within the opening in the cover to permit expansion of the organizer as additional material is received by and stored within the organizer. A strap is available to secure the organizer in a closed position or to assist in maintaining the organizer in a standing display position.

### BACKGROUND OF INVENTION

There are a variety of binder and planner type products which serve to store and organize documentation and other material, such as notebooks, pads, photographs, small calculators, writing implements, computer floppy and compact discs. Such products are advantageously used as organizers for businesses, tax and financial planning, schools, meetings, social events, like weddings and parties, and other situations where planning and event organization, management, and presentation are required.

However, to date there are no event planner or organizer products which allow for the simple and convenient storage and accumulation of a variety of types of event material in one compact, easy to use, versatile receptacle.

### SUMMARY OF INVENTION

As a result, it is an object of the present invention to overcome the limitations and disadvantages of prior event organizers. It is an object of the present invention to provide an event or planning organizer which has a variety of uses, including, but not limited to, an organizer and planner for weddings, parties, businesses, schools, meetings, college, taxes and finances, custom home projects, real estate transactions, and any situations where planning, organization, management and/or presentation are required.

It is another object of the present invention to provide an event or planning organizer which is compact, versatile and easy to use.

It is a further object of the present invention to provide an event or planning organizer which is capable of receiving and storing a variety of different items, including documentation, computer accessories, and stationery supplies.

It is still another object of the present invention to provide an event or planning organizer which is capable of detachably securing items such as folders and notebooks.

It is still a further object of the present invention to provide an event or planning organizer which is readily and easily expandible, during storage and accumulation of documentation and event materials.

It is another object of the present invention to provide an event or planning organizer which can be used as a display board for presentation purposes.

It is still a further object of the present invention to provide an event or planning organizer which can be sized to be readily and securely closed, regardless of the quantity of documentation and event material contained therein.

The above objects of the invention and others are satisfied by the present invention, an event or planning organizer comprising dual, rigid covers, onto which organizer components are detachably supported. Items such as a notebook and an expandible folder can be detachably contained within the covers of the organizer. A flexible binder, secured to one of the covers, is insertable into an opening in the other cover, to interconnect the covers and form the organizer. The binder is slidably adjustable within the opening in the cover to permit expansion of the organizer as additional material is received by and stored within the organizer. A strap is available to secure the organizer in a closed position or to assist in maintaining the organizer in a standing display position.

The novel features which are considered as characteristic of the invention are set forth in particular in the appended claims. The invention, itself, both as to its design, construction, and various uses, together with additional features and advantages thereof, are best understood upon review of the following detailed description with reference to the accompanying drawings.

### BRIEF DESCRIPTION OF THE DRAWINGS

FIG. 1 is a perspective view of the organizer in its open position.

FIG. 2 is an exploded view of the organizer in its open position.

FIG. 3 is a perspective view of the organizer in its open position with its folder in an expanded position.

FIG. 4 is a perspective view of the organizer in its closed position.

FIG. 5 is a perspective view of the organizer in its closed position with its folder expanded.

FIG. 6 shows the cover and binder components of the organizer.

FIG. 7 is a view of one of the covers of the organizer.

FIG. 8 is a perspective view of the organizer in its closed, secured position.

FIG. 9 is a perspective view of the organizer in its standing, display position.

FIG. 10 is a perspective view of the organizer in its standing display position, with the alternate closure strap.

### DETAILED DESCRIPTION OF THE INVENTION

Planning or event organizer 1 comprises dual covers 2 and 4 made of rigid book-quality material. Flexible binder 6, described in more detail hereinafter, interconnects covers 2 and 4. Expandible folder 8 is located on the surface of cover 2 and is secured to the cover by means of attachment devices 10, which can be Velcro or like attachment devices. Notebook 11 is likewise secured to the surface of cover 4 by Velcro or similar attachment devices 12. By this configuration, folder 8 and notebook 11 can be used within and in combination as part of organizer 1 or removed from the organizer and used separately.

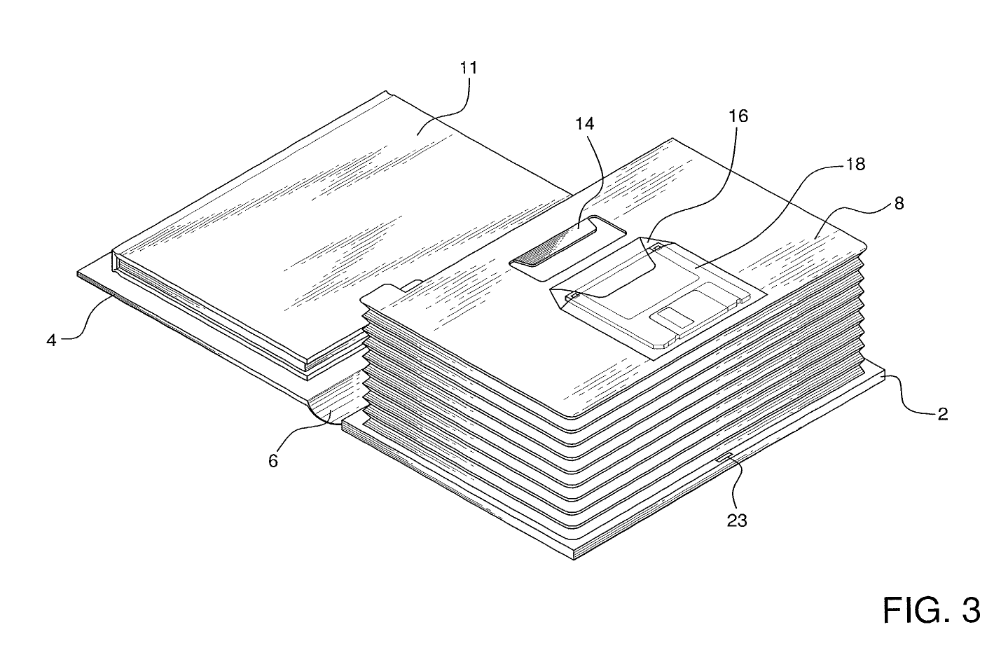

Folder 8 is of expandible, accordion like configuration, as clearly seen in FIG. 3, to allow expansion of the folder as papers and other documentation are placed in it. Folder 8 may also have handle 14 within its outer surface and pocket 16, for such items as a computer disc 18.

It is contemplated that while attachments, such as folder 8 and notebook 11, are shown in the disclosed embodiment of the invention, any combination of these attachments or like attachments, such as paper pads, folders or compartments of various configurations, small calculators or computer devices, or other items which may be relevant to organizing an event or making a presentation, may be used in combination with organizer 1.

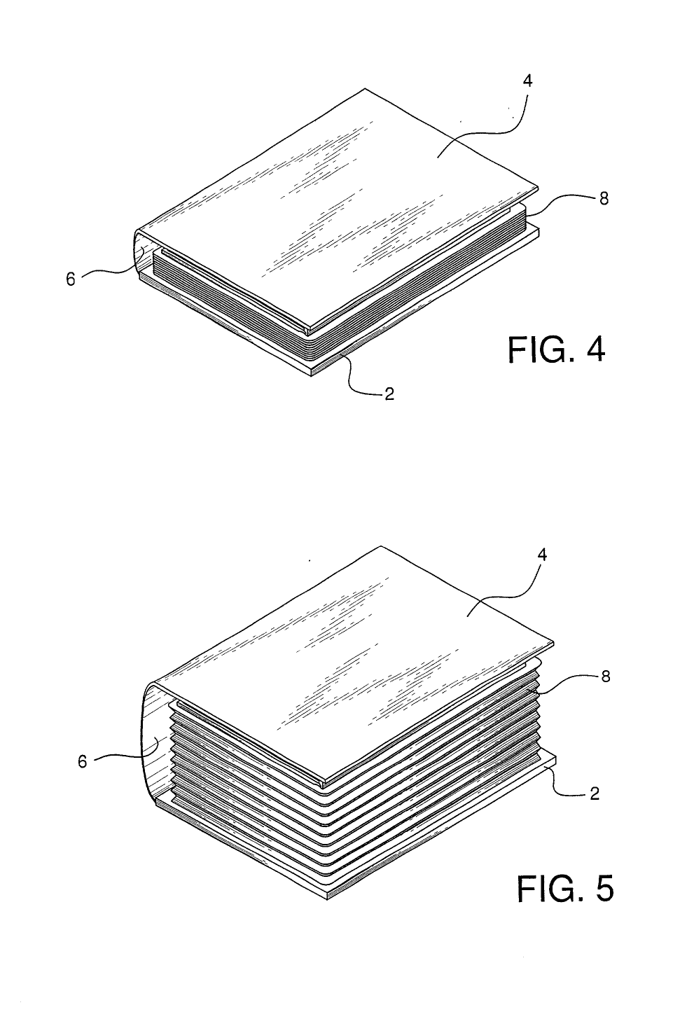

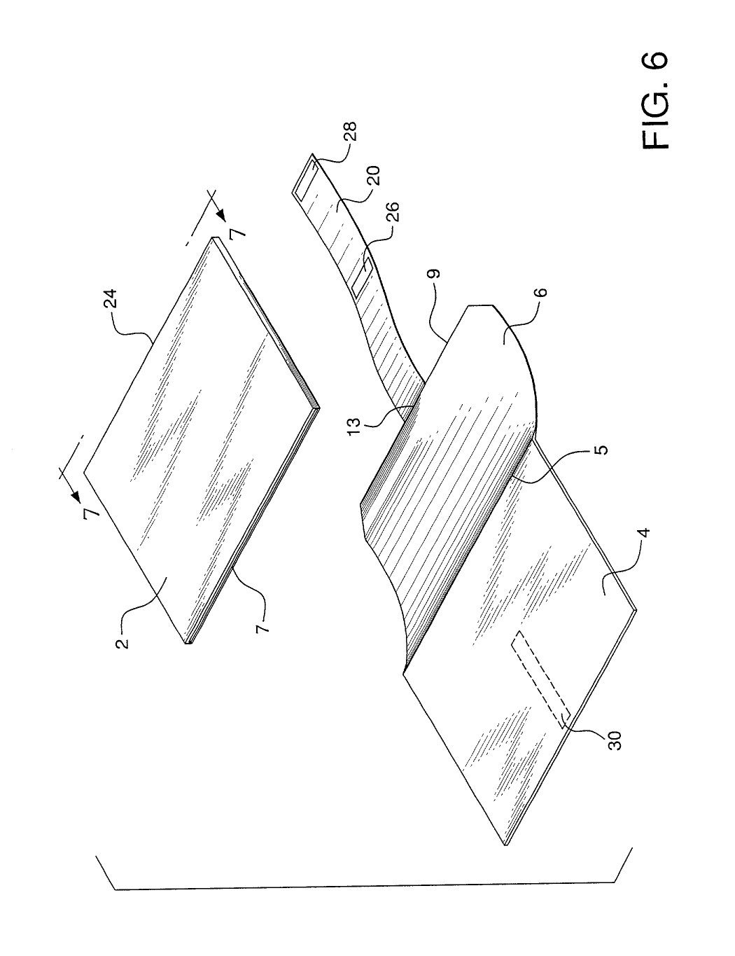

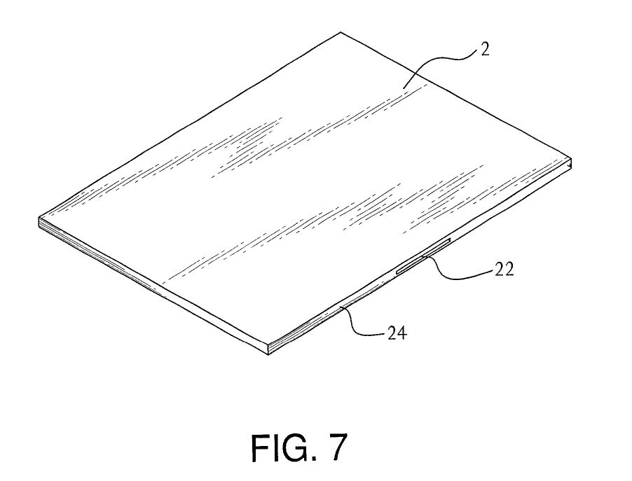

As folder 8 of organizer 1 becomes filled, its accordion like configuration causes it to expand, as best seen in FIG. 3. In order to accommodate this expansion and allow the organizer to conveniently close, as in FIG. 5, an expansion system is provided. As shown in FIG. 6, flexible binder 6 is attached to cover 4 along location 5. Cover 2 comprises opening 7, extending the length of and entirely through the upper and lower surfaces of the cover. Edge 9 of binder 6 is slidably inserted into opening 7. When folder 8 is relatively empty, as shown in FIG. 4, a substantial part of binder 6 is slidably adjusted and positioned within opening 7 of cover 2. As folder 8 receives additional material for storage and thus expands, more of binder 6 is slid out of opening 7 to accommodate this expansion, as shown in FIG. 5.

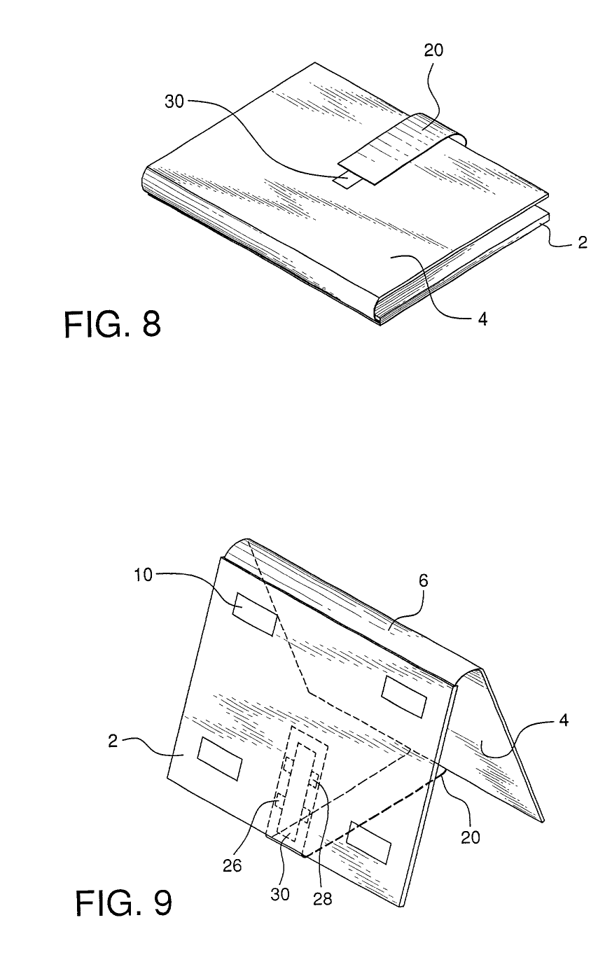

Strap 20 can be secured to binder 6 at location 13 of edge 9. Strap 20 extends through opening 7 of cover 2, exiting through slot 22, located through side 24 of the cover. Strap 20 has Velcro or similar attachments 26 and 28 for connection to corresponding Velcro attachment 30 on cover 4 at various locations on attachment 30, depending on the thickness of folder 8. FIG. 8 shows strap 20 closing and securing organizer 1 in a relatively thin state.

FIG. 9 shows the organizer in use as a stand-up display. Covers 2 and 4 are positioned such that they are resting on their respective side edges, with the their surfaces facing outward. Velcro attachments 10 on the inner surface of cover 2, also face outward and so are available for connection with and display of notebook 11, folder 8, or photographs, charts, or other items or material which may be displayed. Strap 20 is wrapped under covers 2 and 4. Attachments 26 and 28 on strap 20 can then be connected to attachment 30 on cover 2 to assist in securing covers 2 and 4 from movement and for maintaining the configuration of organizer 1 in its displayed position.

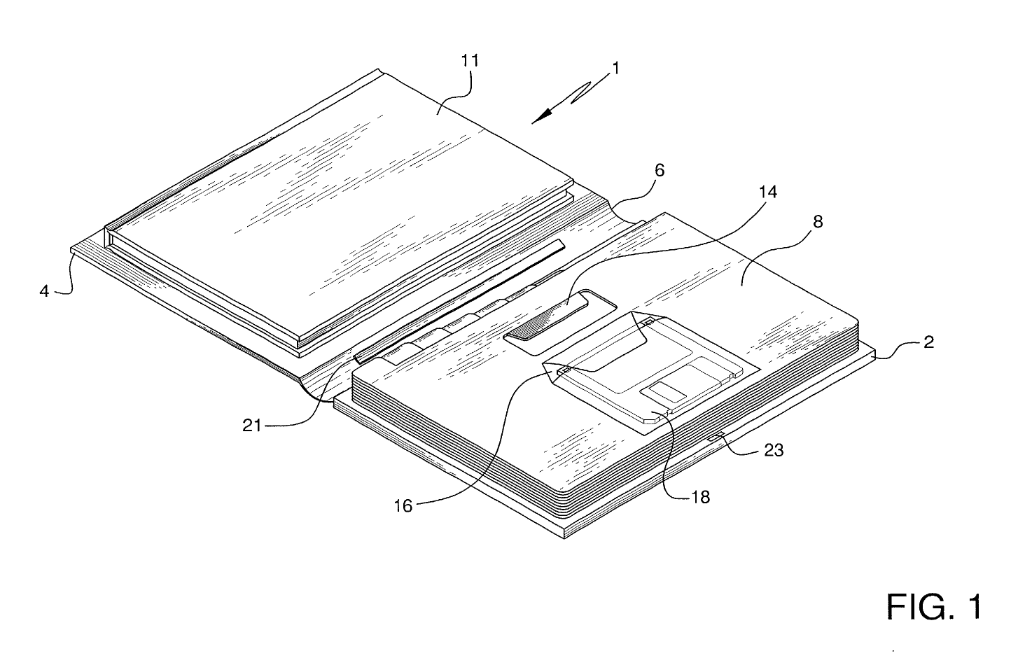

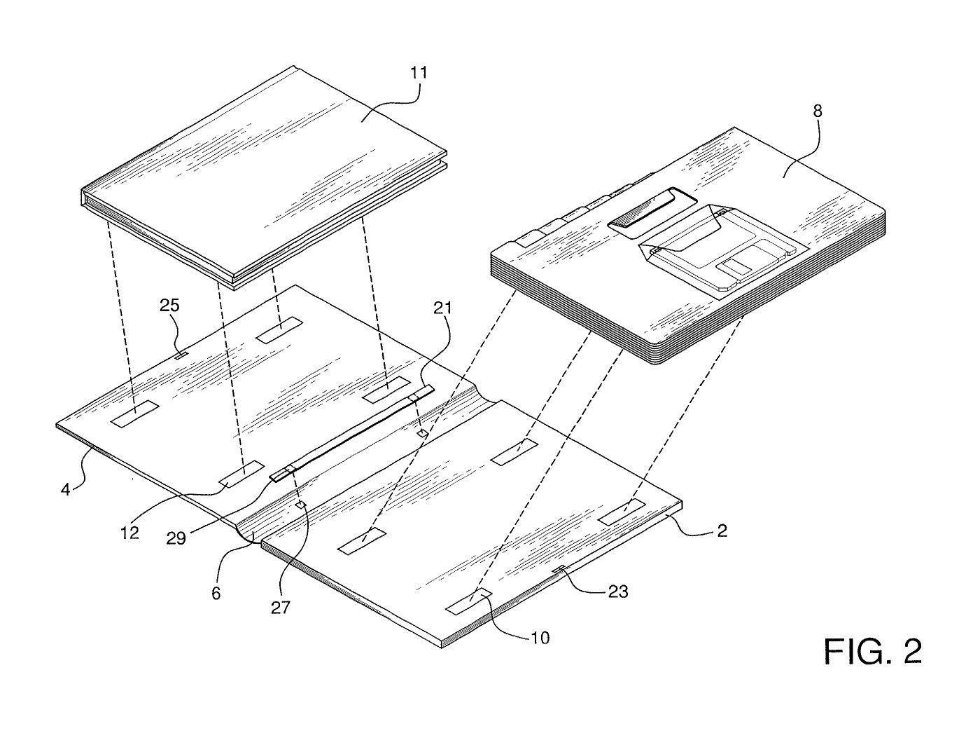

As best seen in FIGS. 1 and 2, a second strap 21 can be provided and secured to binder 6 via Velcro or similar attachments 29, located on either end of the strap, and corresponding attachments 27 located on binder 6.

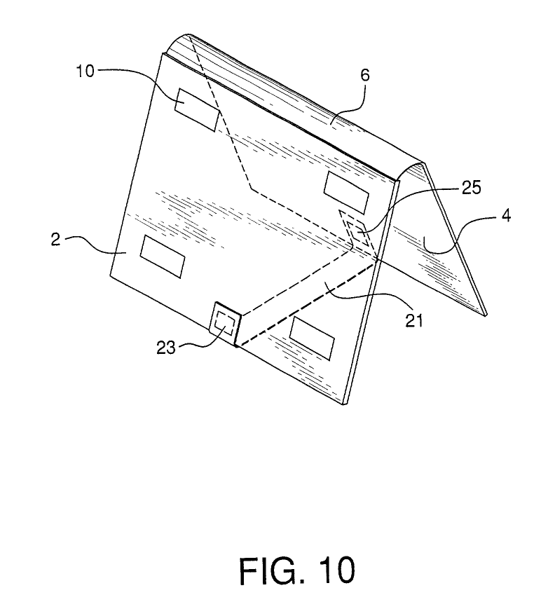

FIG. 10 shows the organizer in use as a stand-up display, employing strap 21. Strap 21 is removed from its attachments on binder 6 and then, with the organizer in the position shown in FIG. 10, wrapped under covers 2 and 4. The two Velcro end attachments 29 of strap 21 are then secured to corresponding Velcro tabs 23 on cover 2 and 25 on cover 4 to maintain the organizer in a standing, upright position. It is also contemplated that strap 21, in this configuration, can be used in combination with strap 20 to maintain the stand-up display. In this situation, strap 12 and tabs 23 and 25 would be positioned offset from the center of the covers 2 and 4.

Certain novel features and components of this invention are disclosed in detail in order to make the invention clear in at least one form thereof. However, it is to be clearly understood that the invention as disclosed is not necessarily limited to the exact form and details and uses as disclosed, since it is apparent that various modifications and changes may be made and uses performed without departing from the spirit of the invention.

1. An event organizer for receiving and storing event material, said organizer comprising:
(a) cover means for enclosing said event material;
(b) means removably connected to the surface of the cover means for receiving and storing event material within the cover means; and
(c) means for expanding the organizer as additional event material is received by and stored within the receiving and storing means.

2. The event organizer as in claim 1 further comprising means within the organizer to detachably connect the means for receiving and storing the cover means.

3. The event organizer as in claim 1 further comprising a notebook detachably connected within the cover means.

4. The event organizer as in claim 2 further comprising a notebook detachably connected within the cover means.

5. The event organizer as in claim 1 further comprising a writing pad detachably connected to the cover means.

6. The event organizer as in claim 2 further comprising a writing pad detachably connected to the cover means.

7. The event organizer as in claim 1 in which the means for receiving and storing event material comprises folder means which expands as event material is received and stored within the folder means.

8. The event organizer as in claim 7 in which the folder means is an expandable accordion folder.

9. The event organizer as in claim 2 in which the means for receiving and storing event material comprises folder means which expands as additional event material is received and stored within the folder means.

10. The event organizer as in claim 9 in which the folder means is an expandable accordion folder.

11. The event organizer as in claim 1 in which the cover means comprises two covers.

12. The event organizer as in claim 11 further comprising means to secure the covers in a closed position.

13. The event organizer as in claim 12 in which the means to secure the covers comprises a strap extending from one of the covers.

14. The event organizer as in claim 11 in which the means for expanding the organizer comprises a flexible binder section extending from one of the two covers of the cover means and an opening formed within the second of the two covers of the cover means into which a portion of the binder section is positioned, whereby the binder section is slidably adjustable within the opening to accommodate the quantity of event material received by and stored within the receiving and storing means.

15. The event organizer as in claim 14 further comprising a means to secure the covers in a closed position.

16. The event organizer as in claim 15 wherein the means to secure the covers comprises a strap extending from the cover.

17. The event organizer as in claim 7 in which the folder means further comprises a compartment for storage.

18. The event organizer as in claim 9 in which the folder means further comprises a compartment for storage.

19. An event organizer for receiving and storing event material, said organizer comprising:
(a) two separate cover sections, one of the cover sections comprising a flexible binder section and the second cover section comprising an opening into which the binder section is slidably positioned;
(b) folder means for receiving and storing event material, said folder means being positioned between the two covers and being expandible to receive and store event material, whereby as event material is received and stored in the folder means, the folder means expands and the binder section is slidably adjusted within the opening to accommodate the amount of material between the covers; and
(c) means to detachably connect the folder means to one of the covers, to allow removal of the folder means from the organizer.

20. An event organizer for receiving and displaying event material, said organizer comprising:
(a) dual cover means forming the organizer, said cover means having surfaces for removably connecting and displaying event material;
(b) means for removably connecting event material to the surfaces of the cover means; and
(c) means interconnecting the dual cover means to maintain the organizer in an upright position for displaying event material.

21. The event organizer as in claim 20 wherein the means for interconnecting the dual cover means comprises a flexible binder section between the dual cover means.

22. The event organizer as in claim 20 wherein the means for interconnecting the dual cover means comprises a strap securing the dual cover means from movement while in the upright position.

23. The event organizer as in claim 21 wherein the interconnecting means further comprises a strap securing the cover means from movement while in the upright position.

24. An event organizer for receiving and displaying event material, said organizer comprising:
(a) two separate cover sections with surfaces for removably connecting and displaying event materials, said cover sections each having side edges;
(b) means for removably connecting event material to the surfaces of the cover sections;
(c) means interconnecting the two cover sections to maintain the organizer in an upright position on the side edges of the cover sections, for displaying event material.

25. The event organizer as in claim 24 wherein the means for interconnecting the cover sections comprises a flexible binder section between the two covers.

26. The event organizer as in claim 24 wherein the means for interconnecting the two covers comprises a strap securing the covers from movement while in the upright position.

27. The event organizer as in claim 25 wherein the interconnecting means further comprises a strap securing the covers from movement while in the upright position.

28. An event organizer for receiving, storing, and displaying event material, said event organizer comprising:
(a) cover means for enclosing said event material when event material is stored in the event organizer and for displaying event material, when the even organizer is used for displaying purposes;
(b) means removably connected to the cover means for receiving, storing, and displaying event material on the cover means; and
(c) means for expanding the cover means as additional event material is received by and stored within the receiving and storing means and for maintaining the organizer in an upright position for the display of event material.

29. The event organizer as in claim 28 in which the cover means comprises dual cover means and the means for expanding the organizer interconnects the dual cover means.

30. The event organizer as in claim 29 in which the means for expanding the organizer comprises a flexible binder section extending from one of the dual cover means and an opening formed within the second of the dual cover means into which a portion of the binder section is positioned, whereby the binder section is slidably adjustable within the opening to accommodate the quantity of event material received by and stored within the receiving and storing means.

31. The event organizer as in claim 28 in which the cover means comprises two covers, the organizer further comprising a means to secure the covers in a closed position.

32. The event organizer as in claim 31 in which the means to secure the cover means comprises a strap extending from one of the covers.

33. The event organizer as in claim 28 further comprising means on the cover means to detachably connect the means for receiving and storing event material.

34. The event organizer as in claim 28 in which the means for receiving and storing event material comprises folder means which expand as event material is received and stored within the folder means.

35. The event organizer as in claim 34 in which the folder means is an expandable accordion folder.

36. The event organizer as in claim 28 in which the cover means have side edges, whereby the means for expanding the cover means maintains the organizer in an upright position on the side edges of the cover means, for displaying event material.
